(19) United States
(12) Patent Application Publication
(10) Pub. No.: US 2010/0262491 A1
(43) Pub. Date: Oct. 14, 2010

(54) SEARCHABLE ON-LINE BUSINESS CARD SYSTEM

(76) Inventor: Kenneth Siciliano, Pembroke Pines, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/702,532

(22) Filed: Feb. 9, 2010

Related U.S. Application Data
(60) Provisional application No. 61/150,900, filed on Feb. 9, 2009.

(51) Int. Cl. G06Q 30/00

(52) U.S. Cl. 705/14.51; 705/14.71

(57) ABSTRACT

An on-line database of business contact information wherein advertising and maintaining a collection of contacts is disclosed. Information posted on the website by various businesses is presented for browsing by other users. There is a minimal fee associated with uploading contact information, and additional fees associated with posting a business card “banner” advertisement on the site. Each business is assigned a unique card code and may update disclosed contact information. Such cards can be customized using browser plug-ins and/or pre-selected templates as provided by the website host. Links to individual businesses are active such that websites are accessible through the contact card. Users can generate, store, and search their own database which is maintained by the site. Contact information of non-members can be added by the user and stored in the personalized database from a blank template. Searching of the global or personal database can be achieved by name, business type, city, zip code or card code.

### CROSS REFERENCE TO RELATED APPLICATIONS

This application claims the benefit of provisional U.S. Patent Application Ser. No. 61/150,900, filed on Feb. 9, 2009.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all rights whatsoever.

### BACKGROUND OF THE INVENTION

1. Field of the Invention

This invention relates generally to the field of electronic commerce and more particularly to an Internet website which provides a searchable database of contact information, including the ability to upload information to create a personalized electronic card, search for a specific contact or business name, search by name, topic or trade, build an electronic database of personal contacts, and/or advertise a business by purchasing “preferred” banner space.

2. Description of Related Art

There are various ways to advertise goods or services. Traditional methods include posting an advertisement in a newspaper, magazine, or trade journal. Alternately, telephonic methods such as cold-calling or computer-generated bulk messages may be utilized. Expensive methods include leasing of billboard space, telephone book advertising, and direct-mail marketing, which have been used as high-profile alternatives. Historically, these methods have been the most successful at reaching thousands of potential clients. Unfortunately, in addition to their expense, such methods do not necessarily reach the targeted audience of the advertiser. Additionally, once the advertisements had been printed, alterations were not easily achievable. Further, as e-commerce expands internationally, the market demands greater access to global business information.

There remains a need in the art for advancements in the field of electronic commerce to allow for the dissemination of business card contact information in the form of an on-line searchable database of personal contacts and advertising merchants, which is user-friendly and designed for easy upload of new contact information.

### BRIEF SUMMARY OF THE INVENTION

The present invention overcomes the limitations and disadvantages in the art by using a global computer network, such as the Internet, to provide an on-line database wherein business information may be posted, searched, altered, and stored by the user such that global business information may be accessed and advertised. The invention provides a method and system for displaying and accessing customized business card information whereby participants may elect to maintain contact information for a minimal monthly fee, and where changes or alterations are easily achievable and where the scope of advertising is global. In a preferred embodiment, the business information is that contained on otherwise conventional business cards, which information is scanned and uploaded to the system as a digital image file or other suitable file format. Further, by using the integrated internal search method, a specific business name or particular type of business may be located. Alternate search options include locating a business by zip code or pre-assigned card code. Selected business cards may be archived in a user's personal database. Once an advertiser's card is selected, an auto-generated message is transferred to the advertiser advising that their business has been added to a user's database. Additional capabilities include a mobile-user friendly version and browser plug-in features. User accounts may be created to allow each user to archive business card information in the user's personal “rolodex” file.

Accordingly, it is an object of the present invention to provide an Internet based searchable business card system.

Another object of the present invention is to provide such a system wherein participants may upload information on pre-formatted card templates for personal use or advertising purposes.

Another object of the present invention is to provide a database for current information about businesses in a global market, which has the capability to link the user to the advertiser's website.

These and other objects are met by the present invention which will become more apparent from the accompanying drawing and the following detailed description of the drawings and preferred embodiments.

### BRIEF DESCRIPTION OF THE SEVERAL VIEWS OF THE DRAWINGS

FIG. 1 is an illustration of a home page of a web-based electronic business card system according to the preferred embodiment of the present invention; and

FIG. 2 is an illustration of a search results page according to a preferred embodiment of the invention;

FIG. 3 is an illustration of a template page for on-line creation of business cards and up-loading of business card images;

FIG. 4 is an illustration of a personal profile page showing a collection of selected business cards stored for a registered user;

FIG. 5 is an illustration of a log-in page; and

FIG. 6 is an illustration of a registration page.

### DETAILED DESCRIPTION OF THE INVENTION

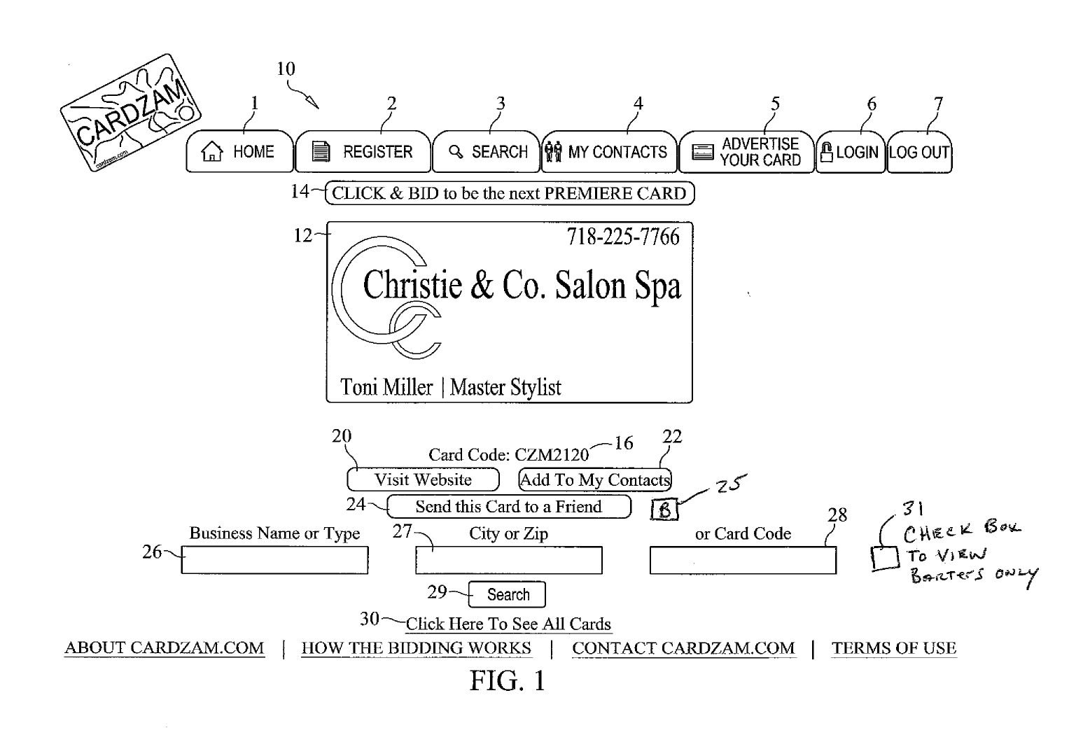

With reference now to the drawings, FIGS. 1-4 depict a preferred embodiment of a computer implemented business contact information advertising and management system comprising an Internet based business card system, wherein users may search the existing database of contacts, create their own contact card, advertise, and build a personal contact list. FIG. 1 illustrates the home page for an Internet based business card system home page, generally referenced as 10, in accordance with the present invention. A computer implemented business contact information advertising and management system in accordance with the present invention comprises an internet website accessible via a global computer network, wherein the website resides on a computer server which is in communication with a database. The database includes a plurality of advertiser records wherein each record including a business card image file containing business contact information for a corresponding advertiser and a unique code. Various search and customization features will be more fully discussed hereinbelow.

As best illustrated in FIG. 1, the home page displays a plurality of navigation buttons including “Home” referenced as 1, “Register” referenced as 2, “Search” referenced as 3, “My Contacts” referenced as 4, “Advertise Your Card” referenced as 5, and “Login” and “Logout” buttons referenced as 6 and 7 respectively. In addition, the main page preferably displays a Premier Card, referenced as 12. Premier card 12 comprises an advertiser record comprising a business card image for a registered user/advertiser who has obtained the right to have his/her business card displayed on the home page by having the highest bid in a monthly bidding process that generates revenue for the site. The term “advertiser record” in the context of the present invention means, without limitation, information including a business card image, card code, website link. The term “business card image” in the context of the present invention means either a digitized and uploaded image of the user's actual business card, or a user created business card created by filling in fields in one or more template forms available for use with the system. A “Click & Bid” button 14 allows the user to submit a bid to have his/her card identified as the Premier card for the next display period, typically monthly. The Premier card 12 is preferably selected through a silent-auction type process, wherein the highest bidder's card is featured for a one-month segment. In accordance with a preferred embodiment, premier card 12 is presented as a static display. In an alternate embodiment, premier card 12 may comprise a scrolling display of several cards. The premier card, as well as every other card in the system is assigned a unique card code, referenced as 16, which may be displayed in connection with the card display. Providing each record with a unique card code is significant is allowing for rapid location of individual card records.

The present invention further includes a number of functions associated with each business card for ease of navigation and information handling. For example, a “Visit Website” button 20, provides the user with a single click means of visiting a website associated with the selected business card. As should be apparent, clicking button 20 opens the associated link to the advertiser's website, preferably as an overlay screen. An “Add To My Contacts” button 22, allows the user to add the selected business card to his/her personal business card folder. A “Send This Card To A Friend” button 24 allows the user to forward a copy of the selected business card to a third party via e-mail. A Barter icon 25 is displayed if the advertiser has indicated a willingness to engage in Barter transactions as more fully discussed below.

On the bottom portion of the home page there is an area dedicated to functions that allow the user to search for business cards. More particularly, fields are presented that allow the user to search based on a business identifier, i.e. “Business Name or Type”, referenced as 26, based on a geographic location, i.e. “City or Zip”, referenced as 27, and based on “Card Code”, referenced as 28. A search button 29, functions to perform the search based on the information provided by the user in one of the search fields 26, 27, or 28. The search feature searches cards in the system database based on the key words/information supplied by the user. The homepage includes a button, referenced as 30, that allows the user to see all cards in the database, and a box 31 that, when checked, configures the system to only display.

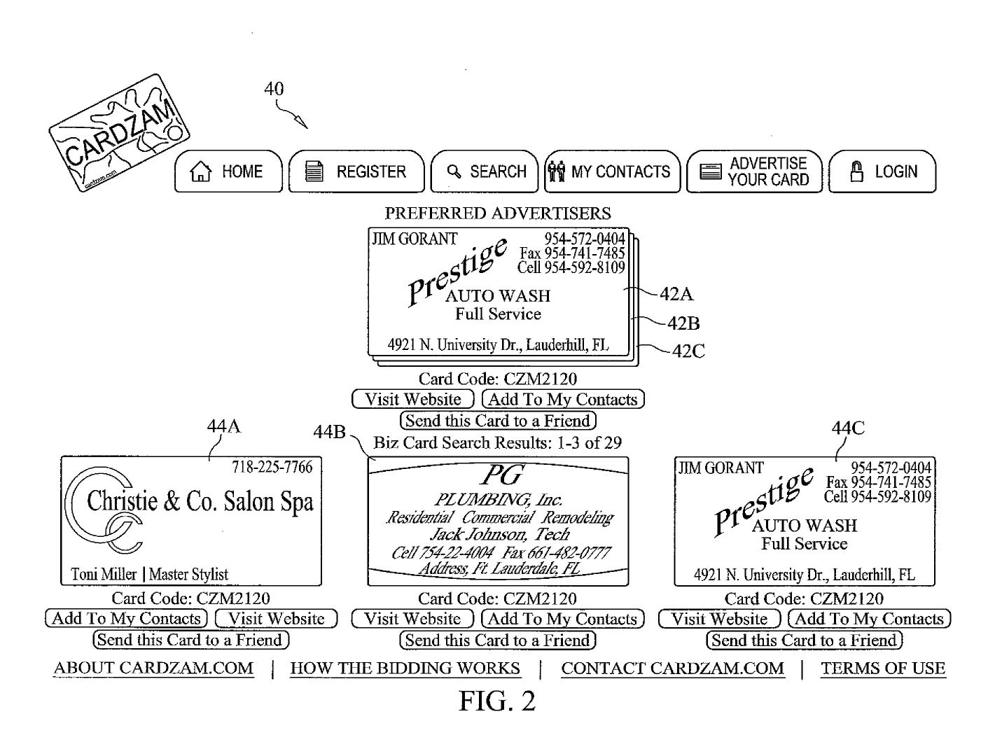

FIG. 2 illustrates a search results page, generally referenced as 40, that displays the results based on the user's search query. Located near the top of the page is a preferred advertiser section wherein the business cards of preferred advertisers, referenced as 42A, 42B, 42C, etc., appear in an automatically sequentially scrolling display. Preferred advertisers are advertisers who have paid a premium for the privilege of having their cards appear on the search results page. Preferred advertiser cards may appear regardless of whether they match the search criteria. In an alternate embodiment, the preferred advertiser cards may consist of a subset of those cards that meet the search criteria. In a preferred embodiment, the preferred advertiser cards (42A, 42B, 42C, etc.) are presented one at a time, and a random selection of cards continuously scrolls for viewing by the user. Directly below preferred advertiser section, additional search results. More particularly, those business cards, referenced as 44A, 44B, and 44C, that meet or otherwise satisfy the search criteria, are displayed in one or more rows and columns. Any particular card in the database may be selected by the user upon clicking on it. As disclosed herein above, each card displayed is associated with a card code, an “Add to My Contacts” button, a “Visit Website” button, and a “Send This Card to a Friend” button as illustrated in FIG. 1.

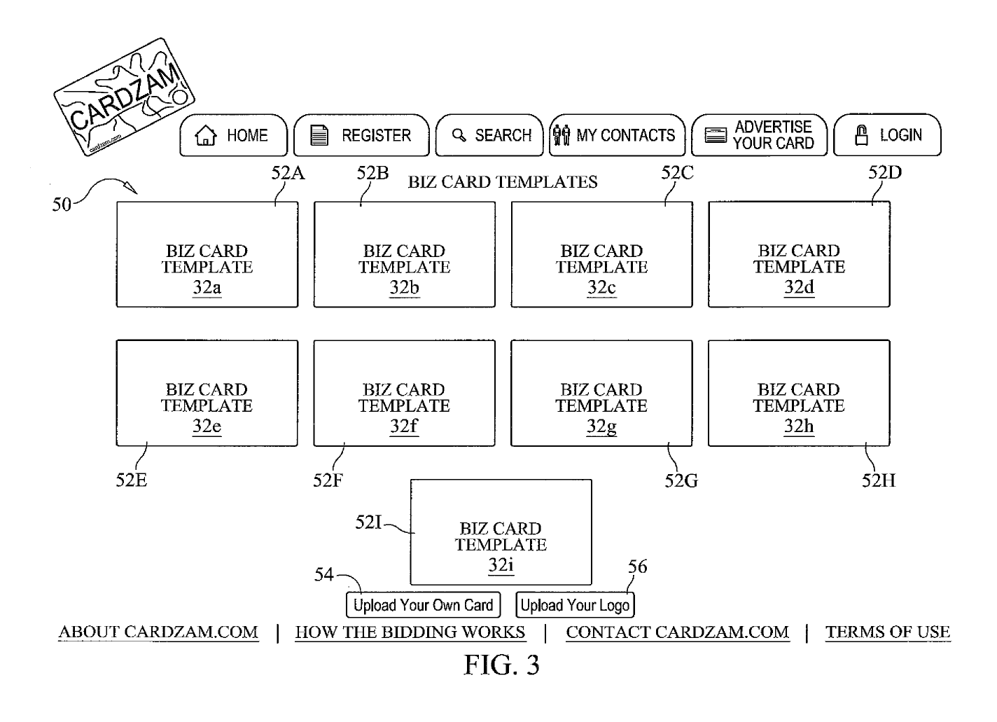

FIG. 3 is a schematic diagram illustrating a template page, generally referenced as 50, for use in designing and setting up a template based business card for use with the system and/or uploading existing business card images. This page presents nine unique templates (52A, 52B, 52C, 52D, 52E, 52F, 52G, 52H, and 52I) allows the advertiser to customize the look of their card. Characteristics of the templates include variations in background, color, font, text size, and format. Sufficient space on each card is allocated such that company name, address, phone/facsimile/cellular numbers, and email or website addresses can be entered. In addition, a plug-in feature button 54 allows an advertiser to essentially upload his/her own business card. An additional feature button 56 allows an advertiser to upload a logo to be inserted in one of the templates 52.

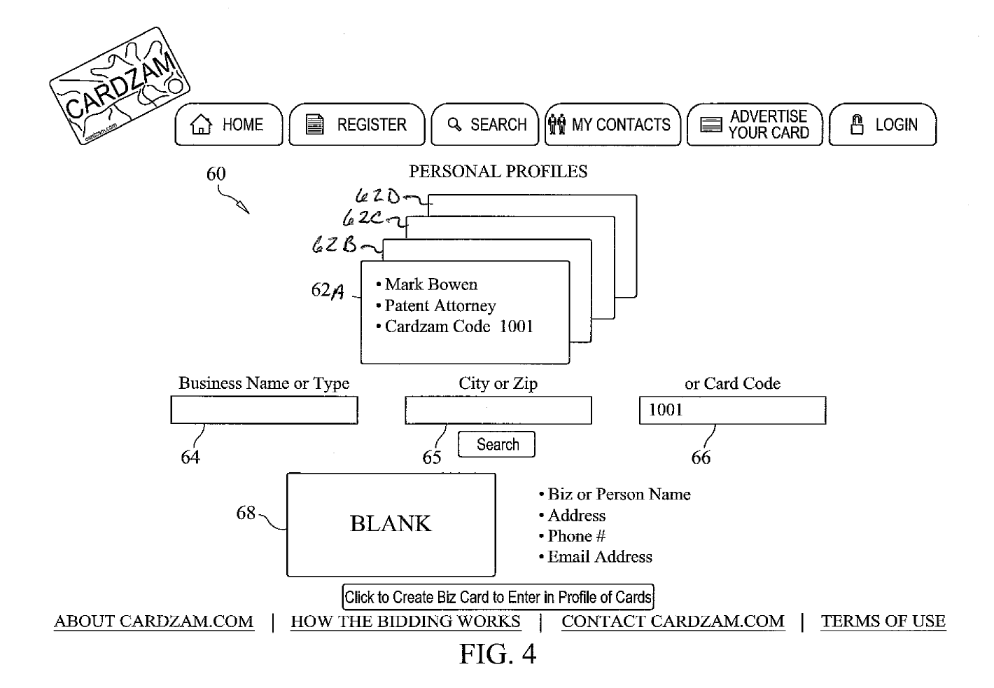

FIG. 4 is a schematic illustration of the personal profile, generally referred as 60, of business cards for a given registered/subscriber user saved in a rolling index format. Providing business card information in a rolling format is considered an important aspect of the present invention as it presents electronically stored business cards in a customary and recognizable format. This page displays a compilation of personal contact cards 62A-62D and is searchable by business name 64, city or zip, 65, or card code 66. A blank template 68 is featured below the search boxes such that a personal contact may be added to the personal profile, even when that contact has not created their own card within the system. In a preferred embodiment, a browser plug-in feature allows provides an application that allows a user to automatically format and import contact information from non-subscriber websites into the user's personal index thereby allowing the user to accumulate contact information from sources that have not uploaded contact information into the database. In accordance with this embodiment, the plug-in feature will convert contact information available on any given website into a format suitable for use with the database functions of the present invention. Once uploaded the contact information may then be viewed or even printed in widely accepted formats for easy mailing, or courier transfer via UPS, FEDEx, etc.

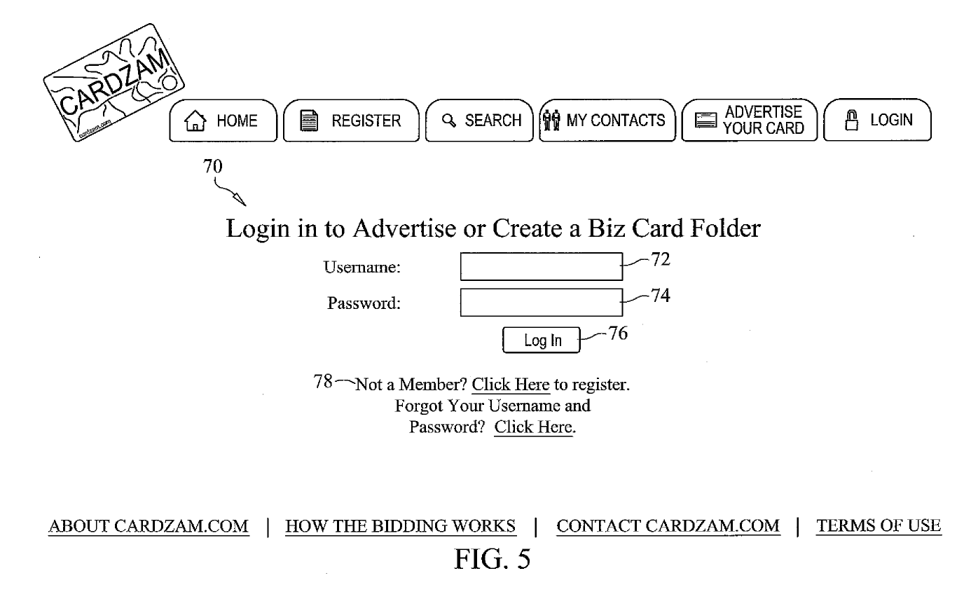

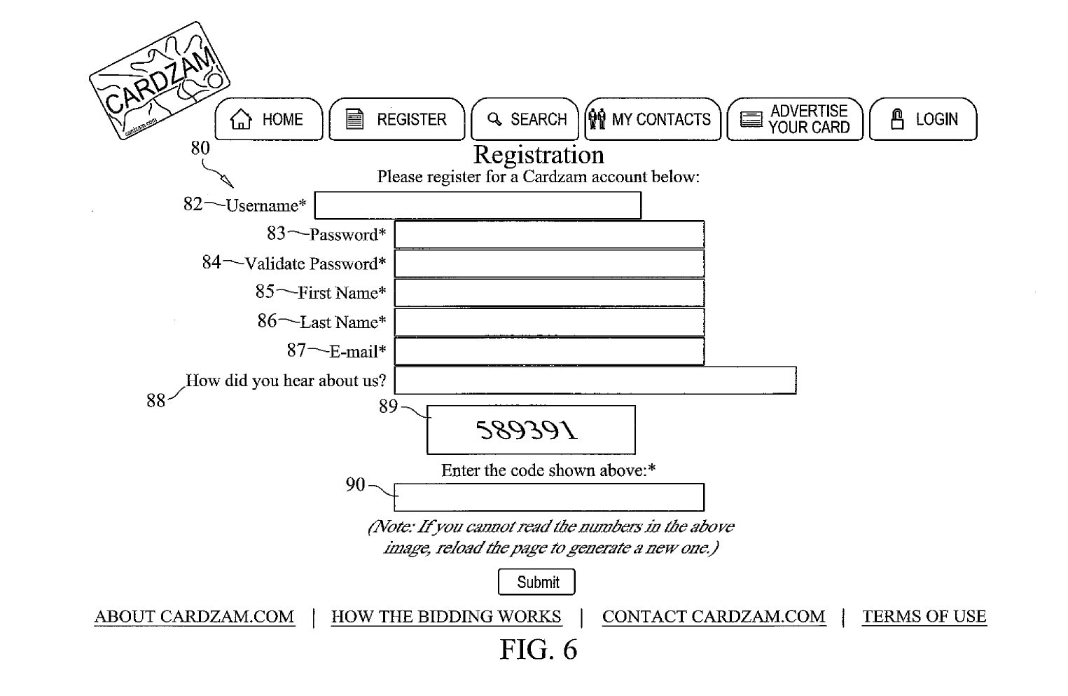

FIG. 5 illustrates a login page, generally referenced as 70, to allow user's to login to a previously created account or to create a new account. Input fields referenced as 72 and 74 are provided to receive “user name” and “password” respectively. A “log in” button 76 functions as an enter key to accept the entries in input fields 72 and 74. To the extent that the user is not registered, a new member button 78 functions to direct the user to a registration page 80 as illustrated in FIG. 6. Registration page 80 provides a plurality of input fields to accept user information. Included are fields for user name 82, password 83, password validation 84, first name 85, last name 86, e-mail address 87, and origination inquiry (e.g. How did you year about us?) 88. In addition, a security system prevents use of the system by remote automated systems. Accordingly, an security field 89 is populated with a security code, and an input field 90 requires the user to input the displayed security code. Upon receipt of the required information and entry of the proper security code the user is allowed to fully access the system.

In an alternate embodiment, advertisers are provided with an opportunity to participate in a barter program. In accordance with this embodiment, advertisers are provided with an option to participate in a program that allows for the exchange of goods and services through barter. The advertiser may signal his election to participate in the barter program upon registration and posting of his business card, or at any time by simply logging in and making the election. Likewise, advertisers may opt out of the barter process at any time.

If the advertiser elects to participate in the barter program, an icon will be displayed along with the advertiser's business card. In addition, the business cards for all participants in the barter program will be stored in a database of barter participants. These particular business cards will be part of the same database as all of the other advertised business cards, however, they will only be displayed once someone searches for them using a the designated barter members search field.

A designated area on the home page 10 will indicate how a person may search for a barter program member. Once the searcher identifies the type or category of business they would like to barter with, a display of business cards will appear with the barter icon. Searchers can narrow their search by either business name, business type, city or zip code, or by entering the card code number. After a business is selected from the search results (e.g. displayed business cards) the searcher can click on the barter icon or the card itself which will result in the selected card only being displayed. The selected card will appear with a comments box next to the card that includes a message regarding the scope of barter entered by the selected card's advertiser. In addition, a link to the barterer's e-mail address will appear such that the searcher can contact the barter advertiser directly.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A computer implemented business contact information advertising and management system comprising:
an internet website accessible via a global computer network;
said website residing on a computer server;
said computer server in communication with a database;
said database including a plurality of advertiser records, each record including a business card image file containing business contact information for a corresponding advertiser and a unique code;
said website including a homepage configured to always display one of said advertiser records predetermined time period;
said homepage further including search input fields for allowing a user to search advertiser records stored on said database;
said website including a search results page configured to display advertiser records corresponding to search terms entered by the user in said search input fields on said home page;
said website including an upload page to facilitate the creation of advertiser records and the uploading of business card image files, said upload page further including a plurality of business card templates to allow for the creation of business card image files; and
said website including at least one personal profile page corresponding to a user, said personal profile page including a compilation of advertiser records selected by the user.

2. A computer implemented business contact information advertising and management system according to claim 1, wherein each advertiser record further includes a link to the advertiser's website.

3. A computer implemented business contact information advertising and management system according to claim 1, further including a function button associated with each advertiser record to allow the record to be added to a user's personal profile page.

4. A computer implemented business contact information advertising and management system according to claim 1, wherein said search input fields include fields selected from at least one of the following: (a) business names or type, (b) geographic location, and (c) card code.

5. A computer implemented business contact information advertising and management system according to claim 1 wherein said advertiser records further include an indication as to whether each advertiser is interested in barter transactions.

6. A method of providing a computer implemented business contact information advertising and management system comprising the steps of:
providing an internet website accessible via a global computer network, said website having a homepage;
allowing advertisers and users to register accounts using said website;
allowing registered advertisers to create advertiser records associated with said accounts, said advertiser records including electronic business cards for display on said website;
assigning a unique card code to each advertiser record;
storing said advertiser records and associated card codes in a computer database;
allowing registered advertisers to bid for preferred exposure on said website whereby the electronic business card for a successful bidder is displayed on the websites homepage for a predetermined time period;
allowing users to search advertiser records using said website;
providing a search results page configured to display advertiser records corresponding to user searches;
allowing registered users to create personal profile pages including a compilation of advertiser records selected by the user.

7. A method according to claim 6, further including providing said website with an upload page to facilitate the creation of advertiser records and the uploading of business card image files, said upload page further including a plurality of business card templates to allow for the creation of business card image files.

8. A method according to claim 6, wherein said advertiser records further include an indication as to whether each advertiser is interested in barter transactions.
